(19) United States
(12) Patent Application Publication
(10) Pub. No.: US 2025/0124497 A1
(43) Pub. Date: Apr. 17, 2025

(54) METHOD

(71) Applicant: TOYOTA JIDOSHA KABUSHIKI KAISHA, Toyota-shi (JP)

(72) Inventor: Ai FUJIMURA, Hirakata-shi (JP)

(73) Assignee: TOYOTA JIDOSHA KABUSHIKI KAISHA, Toyota-shi (JP)

(21) Appl. No.: 18/902,458

(22) Filed: Sep. 30, 2024

(30) Foreign Application Priority Data
Oct. 16, 2023 (JP) 2023-178449

(51) Int. Cl. G06Q 30/0645; G06Q 30/0601

(52) U.S. Cl. CPC G06Q 30/0645; G06Q 30/0625; G06Q 30/0641

(57) ABSTRACT

A terminal apparatus displays, on a screen of the terminal apparatus, a plurality of stations that serves as locations for renting out and returning one or more mobile objects. The terminal apparatus then identifies a group to which each of the plurality of stations belongs. Then, the terminal apparatus displays, among the plurality of stations displayed on the screen, each station that belongs to a first group to which a first station selected from among the plurality of stations by a user belongs in a first mode and each station that belongs to one or more groups other than the first group in a second mode.

### CROSS-REFERENCE TO RELATED APPLICATION

This application claims priority to Japanese Patent Application No. 2023-178449 filed on Oct. 16, 2023, the entire contents of which are incorporated herein by reference.

### TECHNICAL FIELD

The present disclosure relates to a method.

### BACKGROUND

Technology for improving the convenience of a service of renting out mobile objects, such as a car sharing service is known. For example, Patent Literature (PTL) 1 discloses technology in which, when a user has selected a station that serves as the location for renting out and returning mobile objects from among candidates presented, the selection of stations that belong to a group other than the group to which the selected station belongs is restricted.

### CITATION LIST

### Patent Literature

PTL 1: JP 2022-062636 A

### SUMMARY

There is room for improvement with respect to technology for improving the convenience of a service of renting out mobile objects.

It would be helpful to improve technology related to a service of renting out mobile objects.

A method according to an embodiment of the present disclosure is a method performed by a terminal apparatus that provides a service of renting out one or more mobile objects, the method including:
displaying, on a screen of the terminal apparatus, a plurality of stations that serves as locations for renting out and returning the one or more mobile objects;
identifying a group to which each of the plurality of stations belongs; and
displaying, among the plurality of stations displayed on the screen, a station that belongs to a first group to which a first station selected from among the plurality of stations by a user belongs in a first mode and one or more stations that belong to one or more groups other than the first group in a second mode.

According to an embodiment of the present disclosure, technology for improving the convenience of a service of renting out mobile objects is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of an information processing apparatus; and

FIG. 4 is a flowchart illustrating operations of the terminal apparatus.

### DETAILED DESCRIPTION

Hereinafter, an embodiment of the present disclosure will be described.

### Outline of Embodiment

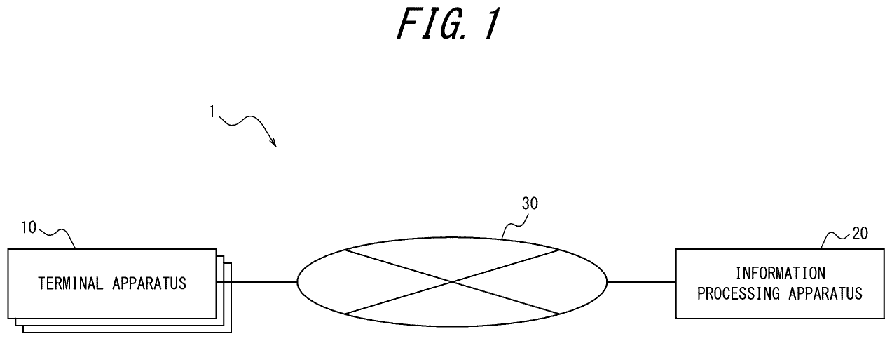

An outline of a system 1 according to an embodiment of the present disclosure will be described with reference to FIG. 1. The system 1 includes a plurality of terminal apparatuses 10 and an information processing apparatus 20. Each terminal apparatus 10 and the information processing apparatus 20 are communicably connected to a network 30 including, for example, the Internet, a mobile communication network, or the like.

The terminal apparatuses 10 are computers, such as personal computers (PCs), smartphones, or tablet terminals, for example, but are not limited to these examples, and may be configured to include various devices.

The information processing apparatus 20 is, for example, a computer such as a server apparatus. The information processing apparatus 20 can communicate with the plurality of terminal apparatuses 10 via the network 30. In the present embodiment, the information processing apparatus 20 may be, for example, a server of an operator that provides a service of renting out mobile objects, such as a car-sharing service.

The present embodiment can be used in applications where stations owned by a plurality of operators providing services of renting out mobile objects are displayed together on a single screen of the terminal apparatus. The “Group” below refers to a group of stations grouped together by the operator that owns the station.

First, an outline of the present embodiment will be described, and details thereof will be described later. The terminal apparatus 10 displays, on a screen of the terminal apparatus 10, a plurality of stations that serves as locations for renting out and returning one or more mobile objects. The terminal apparatus 10 then identifies a group to which each of the plurality of stations belongs. Then, the terminal apparatus 10 displays, among the plurality of stations displayed on the screen, each station that belongs to a first group to which a first station selected from among the plurality of stations by a user belongs in a first mode and each station that belongs to one or more groups other than the first group in a second mode.

Thus, according to the present embodiment, when a user selects one station, the display mode can be changed depending on the group to which the station belongs. For example, when a user selects a station owned by operator A as a rental location when using the service of renting out a mobile object, the user may not be able to select a station other than the one owned by operator A as a return location. In this case, it may be difficult to understand the relationship between user-selected stations and other stations if only station selection is restricted. However, according to the present embodiment, the relationship between the user-selected station and other stations can be provided visually, so the user can easily understand the relationship between each station. Thus, the present embodiment improves the technology for improving the convenience of the service of renting out mobile objects in that the user can easily understand the relationship between the station selected by the user and other stations.

Next, configurations of the system 1 will be described in detail.

### (Configuration of Terminal Apparatus)

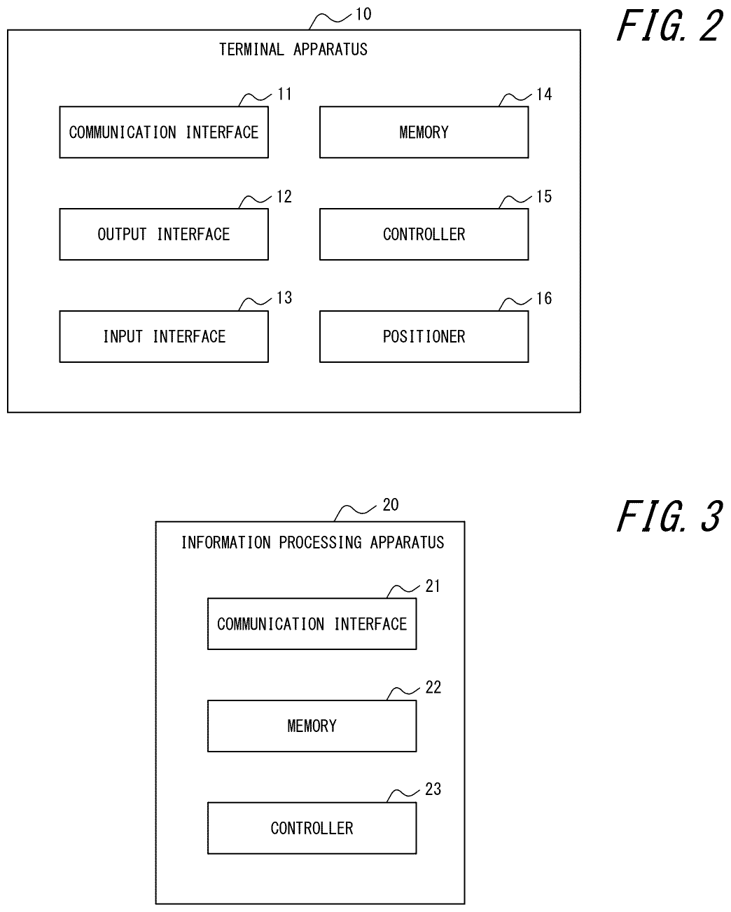

As illustrated in FIG. 2, the terminal apparatus 10 includes a communication interface 11, an output interface 12, an input interface 13, a memory 14, a controller 15, and a positioner 16.

The communication interface 11 includes at least one communication interface for connecting to the network. The interface for communication is compliant with mobile communication standards such as the 4th generation (4G) standard or the 5th generation (5G) standard, for example, but these examples are not limiting. In the present embodiment, the terminal apparatus 10 communicates with the information processing apparatus 20 via the communication interface 11 and the network 30.

The output interface 12 includes at least one output device for outputting information. The output device is a display for outputting information as video, a speaker for outputting information as audio, or the like, for example, but is not limited to these. Alternatively, the output interface 12 may include an interface for connecting to an external output device.

The input interface 13 includes at least one input device for detecting an input operation by the user. The input device is a physical key, a capacitive key, a mouse, a touch panel, a touch screen integrally provided with a display of the output interface 12, a microphone, or the like, for example, but is not limited to these. Alternatively, the input interface 13 may include an interface for connecting to an external input device.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the terminal apparatus 10. For example, the memory 14 may store a system program, an application program, embedded software, and the like. The information stored in the memory 14 may be updated with, for example, information acquired from the network 30 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire terminal apparatus 10.

The positioner 16 includes at least one device for acquiring positional information for the terminal apparatus 10. Specifically, the positioner 16 includes, for example, a receiver compliant with GPS, but is not limited to this example and may include a receiver compliant with any appropriate satellite positioning system.

### (Configuration of Information Processing Apparatus)

As illustrated in FIG. 3, the information processing apparatus 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the plurality of terminal apparatuses 10 via the communication interface 21 and the network 30.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, embedded software, a database, and the like. The information stored in the memory 22 may be updated with, for example, information acquired from the network 30 via the communication interface 21.

The controller 23 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 23 controls the operations of the entire information processing apparatus 20.

### (Flow of Operations of Terminal Apparatus)

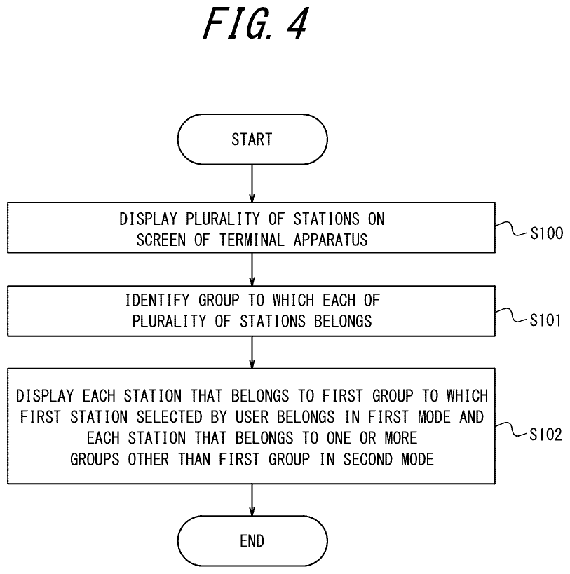

Operations of the terminal apparatus 10 according to the present embodiment will be described with reference to FIG. 4.

S100: The controller 15 of the terminal apparatus 10 displays, on a screen, one of the output interfaces 12 of the terminal apparatus 10, a plurality of stations that serves as locations for renting out and returning one or more mobile objects.

Specifically, the controller 15 receives information from information processing apparatus 20 via the communication interface 11 and the network 30 about a plurality of stations that serves as locations for renting out and returning mobile objects. The controller 15 stores the information of the plurality of stations in the memory 14 and displays the plurality of stations on the screen of the terminal apparatus 10 based on the information on the plurality of stations.

“Information on a station” includes any information indicating the location of the station, such as address or latitude and longitude, and information on the group to which the station belongs, but is not limited to these, and may include any information about the station, such as the size of the station, the price to use the station, the number of mobile objects owned by the station, the number of mobile objects available at the station, the vehicle type of each mobile object owned by the station, customers, and customer loyalty of each customer.

A “group” refers to a group of stations grouped together according to arbitrary conditions, for example, by operators who own the stations, or by areas divided by prefecture, city, town or village. “Information on the group to which a station belongs” includes information that identifies which group each station belongs to, for example, information on the operator that owns the station. Group conditions may be changeable.

The controller 15 may also limit the stations to be displayed on the screen of the terminal apparatus 10, for example, by using the positioner 16 to display stations located in the vicinity of the terminal apparatus 10 on the screen.

For example, the controller 15 may display a form on the screen of the terminal apparatus 10 that allows the user to enter conditions for the stations he/she wishes to display, and limit the plurality of stations to be displayed on the screen of the terminal apparatus 10 based on the conditions entered by the user. For example, if the user enters the vehicle type he/she wants to use as a condition on the screen of terminal apparatus 10, the controller 15 may display on the screen only the stations whose station information includes the information on the vehicle type entered by the user among the information on the plurality of stations stored in the memory 14.

The condition of the station to be displayed may be any condition other than the vehicle type described above.

S101: The controller 15 identifies a group to which each of the plurality of stations belongs.

Specifically, the controller 15 identifies the group to which each of the plurality of stations belongs using the information on the group to which each station belongs contained in each of the plurality of station information stored in the memory 14.

S102: The controller 15 displays, among the plurality of stations displayed on the screen, a station that belongs to a first group to which a first station selected from among the plurality of stations by a user belongs in a first mode and one or more stations that belong to one or more groups other than the first group in a second mode.

Specifically, the controller 15 identifies one of the plurality of stations selected by the user as the first station. Next, the controller 15 may display the stations owned by A (belonging to the first group) in green, which gives people a sense of security, and the stations owned by others (belonging to groups other than the first group) in gray, which gives people a reserved impression, if, for example, the operator who owns the first station selected by the user is A.

The “mode” may be by color, such as red, blue, yellow, etc., by shape, such as circle, double circle, etc., by number or symbol, as described above, for example, but various manners may be used including, but not limited to, the following.

The controller 15 may display the first station in the first mode, or in a mode different from the first and second modes.

The controller 15 may also allow the user to choose whether to select the first station as a rental or return location after the user has selected it. The method of having the user select whether to select as a lending or return location may be, for example, by displaying a message box on the screen of the terminal apparatus 10, but is not limited to this and any method can be employed. Alternatively, the screen for selecting a station as a rental location and the screen for selecting a station as a return location may be separate screens.

The controller 15 may also allow the user to re-select the selected station on said screen.

As described above, the terminal apparatus 10 displays, on a screen of the terminal apparatus 10, a plurality of stations that serves as locations for renting out and returning one or more mobile objects. The terminal apparatus 10 then identifies a group to which each of the plurality of stations belongs. Then, the terminal apparatus 10 displays, among the plurality of stations displayed on the screen, a station that belongs to a first group to which a first station selected from among the plurality of stations by a user belongs in a first mode and one or more stations that belong to one or more groups other than the first group in a second mode.

According to such a configuration, when a user selects one station, the display mode can be changed according to the group to which the station belongs. For example, when a user selects a station owned by operator A as a rental location when using the service of renting out a mobile object, the user may not be able to select a station other than the one owned by operator A as a return location. In this case, it may be difficult to understand the relationship between user-selected stations and other stations if only station selection is restricted. However, according to the present embodiment, the relationship between the user-selected station and other stations can be provided visually, so the user can easily understand the relationship between each station. Thus, the present embodiment improves the technology for improving the convenience of the service of renting out mobile objects in that the user can easily understand the relationship between the station selected by the user and other stations.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the terminal apparatus 10 in the above embodiment are distributed to multiple computers capable of communicating with each other can be implemented. For example, an embodiment in which some or all of the components of the terminal apparatus 10 are provided in the information processing apparatus 20 can also be implemented. For example, the information processing apparatus 20 may be equipped with some or all of the components of the terminal apparatus 10.

For example, in the embodiment described above, the group was a group of stations grouped by the operator that owns the station, but it is also possible to group by other factors. For example, a group may be a group of stations grouped together by any condition, such as the area to which the station belongs (e.g., prefecture, city, town, or village), the type of service of renting out the mobile object (e.g., car rental, car sharing), and so on.

For example, in the embodiment described above, for example, after the user has selected the first station as the lending station, the user may further select the second station as the return location. Here, the controller 15 may redisplay the second station and the stations belonging to the second group to which the second station belongs in a third mode when the second station is further selected by the user from among the plurality of stations while the first station is identified.

Specifically, with the first station identified, the controller 15 identifies one further selected by the user from the plurality of stations as the second station. The controller 15 may then redisplay the second station and the stations owned by B (belonging to the second group) in black, for example, if the first station is owned by operator A and the second station is owned by operator B.

For example, the lending and return locations could be the same. Therefore, the first and second stations may be the same in the present embodiment.

The controller 15 may differ the following process when the second station belongs to the first group and when the second station belongs to a group other than the first group. For example, the controller 15 can employ any different process, such as displaying the next screen if the second station belongs to the first group and displaying a message if the second station belongs to a group other than the first.

For example, in the embodiment described above, the controller 15 may display, among the stations that belong to groups other than the first group, a station that belongs to the third group in a fourth mode. For example, if the first station is owned by operator A, the controller 15 may display stations owned by A (belonging to the first group) in green, stations owned by operator C (belonging to the third group) in yellow, and other stations (belonging to neither the first nor the third group) in stations owned by operator C (belonging to group 3) are shown in yellow, and other stations (belonging to neither group 1 nor group 3) are shown in gray.

For example, in the embodiment described above, the controller 15 may display, among the stations that belong to groups other than the first group, a station that satisfies the first predetermined condition in the first mode. For example, the controller 15 may display, among the stations that belong to groups other than the first group, a station that has paid an additional fee in the first mode.

The first predetermined condition can be any condition other than the payment of the additional fee described above. For example, the first predetermined condition may be an arbitrary condition, such as that the user's customer loyalty to the station is high (if customer loyalty were expressed numerically, it would be above a specified value (e.g., 5)) or that the station is owned by an operator D that is an affiliate of the operator A that owns the first station. The condition may be any condition. The first predetermined condition may be changeable.

For example, in the embodiment described above, the controller 15 may display, among the stations that do not belong to neither the first group nor the third group, a station that satisfies the second predetermined condition in a third mode. The second predetermined condition can be any condition, similar to the first predetermined condition. The first and second predetermined conditions may be the same or different. The second predetermined condition may be changeable.

For example, in the embodiment described above, the controller 15 may display each of the plurality of stations in a manner that a recommendation degree for each of the plurality of stations is distinguishable. Specifically, the controller 15 sets the recommendation degree for each of the plurality of stations. Then, for example, when colors are used for the first and second modes, the controller 15 displays the stations whose recommendation degrees are higher than the specified value in a darker color, and the stations whose recommendation degrees are lower than the specified value in a lighter color. The method of distinguishably displaying each station may be by shape, such as a circle, double circle, etc., or by numbers or symbols, rather than by color, as with the modes, but not limited to these, and various modes different from those used in the first and second modes may be used.

For example, if colors are used for the first and second modes, the controller 15 may display the station in a darker color the higher the recommendation degree, and the station in a lighter color the lower the recommendation degree.

The recommendation degree set for each station may, for example, be set higher, the larger the size of the station. The recommendation degree set for each station may, for example, be set higher, the lower the fee to use the station. The recommendation degree set for each station may, for example, be set higher, the greater the number of mobile objects owned by the station. The recommendation degree set for each station may, for example, be set higher, the greater the number of mobile objects available at the station. The recommendation degree set for each station may, for example, be set higher, the greater the number of vehicle types of the mobile objects owned by the station. The recommendation degree set for each station may, for example, be set higher, the greater the number of times the station has been used. However, the recommendation degree set for each station is not limited to these, and may be set for each of the one or more locations based on various conditions. The recommendation degree set for each station may be based on the result of a combination of the conditions described above.

The conditions used to set the recommendation degrees may be changeable, or may be modified by the user.

For example, in the embodiment described above, when one of the plurality of stations is selected by the user, the controller 15 may identify stations for each of which the recommendation degree is to be changed, among the plurality of stations, and redisplay each of stations for which the recommendation degree has been changed, in a manner that a recommendation degree for each of the stations for which the recommendation degree has been changed is distinguishable, based on recommendation degrees after being changed.

Specifically, for example, if the recommendation degree is based on the price of using a station, and the user uses the first station as a rental location, the price could vary depending on the second station as a return location. In this case, once the first station is identified, the controller 15 resets the recommendation degree for each of the plurality of stations based on whether the station can be selected as a return location, whether or not an additional fee is charged, and the additional fee that is incurred. The controller 15 then displays each of the stations for which the recommendation degree has been reset, in a manner that a recommendation degree for each of the stations for which the recommendation degree has been reset is distinguishable, based on recommendation degrees after being reset.

The conditions of the recommendation degrees to be reset for each of the stations after the first station is identified may be the same or different. For example, if the recommendation degree is set based on the price to use a station and the user has chosen the first station as the return location, the recommendation degree that the controller 15 resets for each of the stations after the first station is identified may be based on the size of each station.

The conditions of the recommendation degrees set for each of the stations after one of the plurality of stations has been selected by the user may be changeable, or may be modified by the user.

For example, an embodiment in which a general purpose computer functions as the terminal apparatus 10 according to the above embodiment can also be implemented. Specifically, a program in which processes for realizing the functions of the terminal apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by a terminal apparatus that provides a service of renting out one or more mobile objects, the method comprising:
displaying, on a screen of the terminal apparatus, a plurality of stations that serves as locations for renting out and returning the one or more mobile objects;
identifying a group to which each of the plurality of stations belongs; and
displaying, among the plurality of stations displayed on the screen, a station that belongs to a first group to which a first station selected from among the plurality of stations by a user belongs in a first mode and one or more stations that belong to one or more groups other than the first group in a second mode.

2. The method according to claim 1, further comprising redisplaying, in a case in which a second station further selected from among the plurality of stations by the user belongs to a second group, with the first station being identified, the second station and a station that belongs to the second group to which the second station belongs in a third mode.

3. The method according to claim 1, further comprising displaying, among the one or more stations that belong to the one or more groups other than the first group, a station that satisfies a predetermined condition in the first mode.

4. The method according to claim 1, further comprising displaying each of the plurality of stations in a manner that a recommendation degree for each of the plurality of stations is distinguishable.

5. The method according to claim 4, further comprising:
identifying, when the first station is selected by the user, stations for each of which the recommendation degree is to be reset, among the plurality of stations; and
redisplaying each of stations for which the recommendation degree has been reset, in a manner that a recommendation degree for each of the stations for which the recommendation degree has been reset is distinguishable, based on recommendation degrees after being reset.
